(19) United States
(12) Patent Application Publication
(10) Pub. No.: US 2017/0265509 A1
(43) Pub. Date: Sep. 21, 2017

(54) Stuffed Nut Snack Food Product

(71) Applicant: Seressa Graham, Smyrna, GA (US)

(72) Inventor: Seressa Graham, Smyrna, GA (US)

(21) Appl. No.: 15/075,127

(22) Filed: Mar. 19, 2016

(51) Int. Cl. A23L 25/00

(52) U.S. Cl. CPC A23L 25/20; A23V 2002/00

(57) ABSTRACT

This application relates to the method of stuffing nuts with food substances, with or without the use of a sticky binder and the product thereof formed into bite-sized, open-faced or closed sandwich shapes. In certain embodiments, the stuffed nut snack food product is coated in sauce, candy, yogurt, nut butter, chocolate or combinations thereof.

### STATEMENT REGARDING FEDERALLY SPONSORED RESEARCH OR DEVELOPMENT

Not Applicable

### CROSS-REFERENCE TO RELATED APPLICATIONS

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

This application relates to a stuffed nut snack food product, and more particularly, to an edible nut stuffed with food substances and a sticky binder where necessary or desired, formed into bite-sized, open-faced or closed sandwich shapes. Using split nut halves, food substances can be applied to a nut half, with or without the use of a sticky binder, thereby forming an open-faced sandwich shape or put together with another split nut half to form a closed sandwich shape. The food substance stuffing alone may be sticky enough to act as a binder by itself. However, if the food substance stuffing is not sticky enough on its own, it will need to function in combination with a sticky binder. The sticky binder acts as a stabilizer, solidifier and additional subtle flavor in the stuffed nut snack food product. This stuffed nut snack food product is stable and does not need pasteurization, sterilization, nor does it need to support fermentation under ordinary conditions. In certain embodiments, the stuffed nut snack food product is coated in sauce, candy, yogurt, nut butter, chocolate or combinations thereof.

### BRIEF SUMMARY OF THE INVENTION

Stuffing fruit, most notably olives and dates, has existed for a long time and is popular; however the reverse of “stuffing” nuts with fruit and other food substances is novel.

Nuts mixtures have become popular as quick energy foods and snacks. These mixtures containing nuts, fruit, granola, cereal and/or candy are commonly referred to as trail mixes, nut clusters or nut bars. These edible matrices use binders, such as oils and sugars, to hold them together in a convenient form for handling and consumption. Though typically available and sold in larger shapes, the current inventions provide a created taste of two or more flavors together in bite-sized snack form.

In certain embodiments, the stuffed nut snack food products are coated in chocolate. Different chocolate-covered food products exist in the market today. For example, chocolate-covered peanuts sold under the name Goobers or peanut M&Ms and chocolate-covered raisins sold under the name Raisinets. These nuts and fruit tend to be whole, use various types of chocolate and may even come in a candy coated shell. One specific embodiment of the present inventions is peanuts stuffed with raisins and dipped in chocolate. This would create a composition and taste similar to eating a Goober or peanut M&M and Raisinet together in a bite-sized form.

Prior to the stuffed nut snack food products of the present inventions, there has not been an example of producing a nut stuffed with a variety of edible fillings. The present inventions, accordingly, present a unique and non-obvious solution by marrying nuts and stuffing (with or without sticky binders). Consequently, it is a general object of the inventions to provide a new and improved snack food.

It is a further object of the inventions to present an aesthetically pleasing stuffed nut snack food product combining multiple flavors in bite-sized, open-faced or closed sandwich shapes.

It is a further object of the inventions to provide a stuffed nut snack food product, which has desirable flavor that is both sweet and/or savory.

It is a further object of the inventions to provide a stuffed nut snack food product which may be coated in sauce, candy, yogurt, nut butter, chocolate or combinations thereof, thereby affecting its appearance and taste.

Further objects of the inventions will appear as the description proceeds.

### BRIEF DESCRIPTION OF THE SEVERAL VIEWS OF THE DRAWINGS

To the accomplishment of the above and related objects, these inventions may be embodied in the form illustrated in the accompanying drawings. Attention being called to the fact, however, the drawings are illustrative only and changes may be made in the specific construction illustrated and described within the scope of the appended claims.

FIG. 1 is a left elevation view of an open-faced stuffed nut snack food product, the right side is identical; and

FIG. 2 is a top elevation view thereof, the bottom view is identical.

FIG. 3 is a side elevation view of a closed sandwich shape stuffed nut snack food product, the other side is identical;

FIG. 4 is a right perspective view thereof, the left side is identical; and

FIG. 5 is a top elevation view thereof, the bottom view is identical.

FIG. 6 is a side elevation view of both the open-faced and closed sandwich shapes stuffed nut snack food products coated in chocolate; the other sides are identical.

FIG. 7 is an exploded view of both the open-faced and closed sandwich shapes stuffed nut snack food products.

With respect to the above description then, it is to be realized the dimensional relationships for the parts of the invention, to include variations in size, materials, shape, form and function are deemed readily apparent and obvious to one skilled in the art. All equivalent relationships to those illustrated in the drawings and described in the specification are intended to be encompassed by the present invention.

### DETAILED DESCRIPTION OF THE INVENTION

The word “nut” in these inventions includes the general culinary definition and those not technically nuts including some seeds, legumes and drupes but not limited to: peanuts, almonds, cashews, pecans, macadamias, pistachios and Brazil nuts. The nuts must be de-shelled and can be raw, roasted or cooked. The nuts can be flavored. The nuts used are available in its separate half form or will be cut to create equal halves. The separated or cut edges should be as smooth as possible and flat as opposed to a rounded edge. The nut halves make up about 50%-66.6% of the stuffed nut snack food product (depending on the desired sandwich shape).

The word “stuffing” in these inventions has two meanings depending on the desired sandwich shape. In the open-faced sandwich shape, it means layering on top of the nut half, and in the closed sandwich shape version, it means filling in between the nut halves. Any food substance can be used in the stuffed nut snack food product as stuffing, such as but not limited to: dried fruit, nut butter, jam, jelly, chocolate, caramel, cheese, candy, pastes, creams, yogurt, nuts, edible plants or combinations thereof. In certain embodiments, the food substance stuffing is diced or chopped into pieces, combined for uniformity into a mixture with one or more binders and then formed into pieces similar to the nut half. The stuffing may be cooked or flavored. The stuffing makes up about 33.3%-50% of the stuffed nut snack food product (depending on the desired sandwich shape).

Any sticky substance can be used in the stuffed nut snack food product as a sticky binder where necessary or desired for flavoring, such as but not limited to: honey, syrup, molasses, nut butter, the sticky insides of dried fruit, marshmallow crème, caramel, chocolate or combinations thereof. In preferred embodiments, the sticky substance binder is a mixture of sticky substances. Once applied to the nut half or halves, the sticky binder should not be really be seen in the end product. The sticky binder makes up less than 1% of both stuffed nut snack food products.

The size of the stuffed nut snack food product is bite-sized and results with a final composition of nuts ranging between 50%-66.6%, stuffing ranging between 33.3%-50% and sticky binder less than 1% where necessary or desired; such that the ratio of nut to stuffing and sticky binder is either 1:1 in the open-faced sandwich shape or 2:1 in the closed sandwich shape.

In certain embodiments, the resulting stuffed nut snack food product is coated in sauce, candy, yogurt, nut butter, chocolate or combinations thereof. The coating may further include a plurality of particulates selected from the group consisting of seeds, nuts, fruit, oats, crispy cereal crumbs, flakes, sprinkles, breading or combinations thereof.

The particularly preferred stuffed nut snack food products provided in accordance with the inventions employ the closed sandwich shape.

The inventions will be better understood and its advantages will become more apparent from the following detailed description of the drawings illustrating the products, preferred version and a preferred embodiment of the inventions.

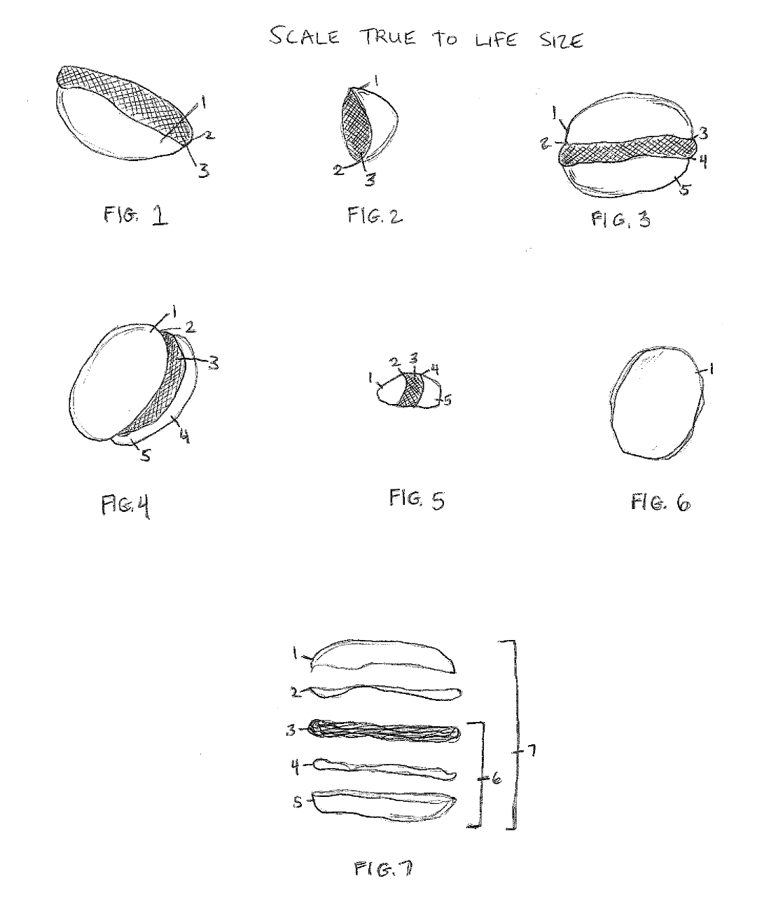

FIGS. 1-2 show different views of the open-faced sandwich shape stuffed nut snack food product using nut half 1, sticky binder 2 (where necessary or desired) and food substance stuffing 3.

FIGS. 3-5 show multiple views of the particular, preferred version of a stuffed nut snack food product as the closed sandwich shape. In this particular embodiment, the stuffed nut snack food product is shown with a top nut half 1, sticky binders 2 and 4 (where necessary or desired), food substance stuffing 3 and a bottom nut half 5. The nut halves 1 and 5 could come from the same type of nut (i.e., two peanut halves), but additionally the top nut half 1 and bottom nut half 5 may come from two different nuts (not shown; i.e., one peanut half and one almond half). A first sticky binder 2 and a second sticky binder 4 are shown spread on the inside surfaces of the top nut half 1 and bottom nut half 5. In embodiments where the food substance stuffing is not enough alone to hold itself together on or in between the split nuts, a sticky binder is necessary and at least one sticky binder must be used. The sticky binder may also be desired to provide subtle additional flavoring. In one particular embodiment, the first sticky binder 2 and second sticky binder 4 are the same (i.e., double peanut butter). In another, they are different (not shown; i.e., honey and peanut butter).

As can be seen in FIG. 6, the stuffed nut snack food product is coated in chocolate 1. Other suitable coatings are not shown. The coatings may further include a plurality of particulates selected from the group consisting of seeds, nuts, fruit, oats, crispy cereal crumbs, flakes, sprinkles, breading or combinations thereof.

FIG. 7 shows an exploded view of both the open-faced sandwich shape 6 and closed sandwich shape 7. This view is supplementary to the fully assembled views above and shows the relationship and order of the various parts. In the open-faced sandwich shape 6, the order is: nut half 5, sticky binder 4 (where necessary or desired) and food substance stuffing 3. The reverse (not shown) is identical: nut half 1, sticky binder 2 (where necessary or desired) and food substance stuffing 3. In the closed sandwich shape 7, the order is: top nut half 1, sticky binders 2 and 4 (where necessary or desired), food substance stuffing 3 and a bottom nut half 5.

Without further elaboration, the foregoing will so fully illustrate my invention that others may, by applying current or future knowledge, readily adapt the same for use under various conditions of service.

I claim:

1. A stuffed nut snack food product yielding a bite-sized, open-faced sandwich shape with final composition of nuts at 50% and stuffing 50% such that the ratio of nut to stuffing is 1:1 comprising: stuffing matrix placed on top of a de-shelled, split or separated nut half.

2. The stuffed nut snack food product of claim 1 wherein the nut is selected from group consisting of peanuts, almonds, cashews, pecans, macadamias, pistachios and Brazil nuts.

3. The stuffed nut snack food product of claim 1 wherein the stuffing is selected from group consisting of dried fruit, nut butter, jam, jelly, chocolate, caramel, cheese, candy, pastes, creams, yogurt, nuts, edible plants or combinations thereof.

4. The stuffed nut snack food product of claim 1 yielding a bite-sized, open-faced sandwich shape with final composition of nuts at ≦50%, stuffing ≦50% and sticky binder ≦1% such that the ratio of nut to stuffing and sticky binder is 1:1 further comprising: a sticky binder placed in between the nut half and stuffing matrix where necessary or desired, to hold sandwich shape together or for additional subtle flavoring.

5. The stuffed nut snack food product of claim 4 wherein the sticky binder is selected from group consisting of honey, syrup, molasses, nut butter, the sticky insides of dried fruit, marshmallow crème, caramel, chocolate or combinations thereof.

6. A stuffed nut snack food product yielding a bite-sized, closed sandwich shape with a final composition of nuts at 66.6% and stuffing 33.4% such that the ratio of nut to stuffing is 2:1 comprising: stuffing matrix placed in between two de-shelled, split or separated nut halves.

7. The stuffed nut snack food product of claim 6 wherein the nut is selected from group consisting of peanuts, almonds, cashews, pecans, macadamias, pistachios and Brazil nuts.

8. The stuffed nut snack food product of claim 6 wherein the stuffing is selected from group consisting of dried fruit, nut butter, jam, jelly, chocolate, caramel, cheese, candy, pastes, creams, yogurt, nuts, edible plants or combinations thereof.

9. The stuffed nut snack food product of claim 6 yielding a bite-sized, closed sandwich shape with final composition of nuts at ≦66%, stuffing ≦33% and sticky binder ≦1%;
such that the ratio of nut to stuffing and sticky binder is 2:1 further comprising: a sticky binder placed in between the two nut halves and stuffing matrix where necessary or desired, to hold sandwich shape together or for additional subtle flavoring.

10. The stuffed nut snack food product of claim 9 wherein the sticky binder is selected from group consisting of honey, syrup, molasses, nut butter, the sticky insides of dried fruit, marshmallow crème, caramel, chocolate or combinations thereof.

11. The bite-sized, open-faced sandwich shape stuffed nut snack food product of claim 1 coated in sauce, candy, yogurt, nut butter, chocolate or combinations thereof.

12. The bite-sized, open-faced sandwich shape stuffed nut snack food product of claim 4 coated in sauce, candy, yogurt, nut butter, chocolate or combinations thereof.

13. The bite-sized, closed sandwich shape stuffed nut snack food product of claim 6 coated in sauce, candy, yogurt, nut butter, chocolate or combinations thereof.

14. The bite-sized, closed sandwich shape stuffed nut snack food product of claim 9 coated in sauce, candy, yogurt, nut butter, chocolate or combinations thereof.
